(19) United States
(12) Patent Application Publication
(10) Pub. No.: US 2023/0421942 A1
(43) Pub. Date: Dec. 28, 2023

(54) METHOD AND APPARATUS FOR AMBIENT SOUND AWARE

(71) Applicant: MEDIATEK INC., Hsin-Chu (TW)

(72) Inventor: Ming-Yu Chen, Hsinchu City (TW)

(73) Assignee: MEDIATEK INC., Hsin-Chu (TW)

(21) Appl. No.: 17/849,686

(22) Filed: Jun. 26, 2022

(51) Int. Cl. H04R 1/10; G10L 25/51

(52) U.S. Cl. CPC H04R 1/1041; G10L 25/51

(57) ABSTRACT

A headset with ambient sound aware function may include at least one microphone (MIC), a storage device, and a processing circuit. The at least one MIC may be arranged to pick up an ambient sound. The storage device may be arranged to store at least one predetermined sound class. The processing circuit may be arranged to receive the ambient sound sent by the at least one MIC, and analyze the ambient sound to detect whether the ambient sound belongs to the at least one predetermined sound class.

### BACKGROUND

With technology develops, a headset may have a pass-through mode which may make a user wearing the headset clearly hear the ambient sound, to prevent potential danger around the user. For example, when the user wearing the headset is walking on the street, the user may switch the headset to the pass-through mode for passing the ambient sound to the user. For another example, when other person talks to the user wearing the headset, the user may also switch the headset to the pass-through mode to clearly hear voice of the other person. Some problems may occur, however. For a conventional headset, the user is required to manually switch the headset to the pass-through mode or switch the headset to the pass-through mode via software installed on an electronic device (e.g. a mobile phone) connected to the headset, which may cause unsafety and inconvenience in use for the headset. As a result, a novel headset that may automatically enable the pass-through mode or send a notification sound signal to the user and associated ambient sound aware method are urgently needed.

### SUMMARY

It is therefore one of the objectives of the present invention to provide a headset with ambient sound aware function that may automatically enable a pass-through mode or send a notification sound signal to a user and associated ambient sound aware method, to address the above-mentioned problems.

According to an embodiment of the present invention, a headset with ambient sound aware function is provided. The headset may include at least one microphone (MIC), a storage device, and a processing circuit. The at least one MIC may be arranged to pick up an ambient sound. The storage device may be arranged to store at least one predetermined sound class. The processing circuit may be coupled to the storage device, and may be arranged to receive the ambient sound sent by the at least one MIC, and analyze the ambient sound to detect whether the ambient belongs to the at least one predetermined sound class. In addition, the headset may further include at least one speaker. In response to detecting that the ambient sound belongs to the at least one predetermined sound class, the processing circuit is further arranged to enable a pass-through mode of the headset, or send a notification sound signal to the at least one speaker.

According to an embodiment of the present invention, an audio system with ambient sound aware function is provided. The audio system may include a headset and an electronic device. The headset may include at least one microphone (MIC), wherein the at least one MIC may be arranged to pick up an ambient sound. The electronic device may include a storage device and a processing circuit. The storage device may be arranged to store at least one predetermined sound class. The processing circuit may be coupled to the storage device, and may be arranged to receive the ambient sound sent by the at least one MIC, and analyze the ambient sound to detect whether the ambient sound belongs to the at least one predetermined sound class. In addition, the headset may further include at least one speaker. In response to detecting that the ambient sound belongs to the at least one predetermined sound class, the processing circuit is further arranged to send a control signal to the headset, wherein a pass-through mode of the headset is enabled according to the control signal, or a notification sound signal is sent from the processing circuit to the at least one speaker according to the control signal.

According to an embodiment of the present invention, an ambient sound aware method for a headset is provided, wherein the headset may include at least one microphone (MIC). The ambient sound aware method may include: picking up an ambient sound by the at least one MIC; and analyzing the ambient sound to detect whether the ambient sound belongs to at least one predetermined sound class storing in a storage device. In addition, the headset may further include at least one speaker. In response to the ambient sound belonging to the at least one predetermined sound class, the ambient sound aware method may further include: enabling a pass-through mode of the headset, or sending notification sound signal to the at least one speaker.

One of the benefits of the present invention is that, the headset (or the audio system that includes the headset and the electronic device) of the present invention can analyze an ambient sound to detect whether the ambient sound belongs to at least one predetermined sound class. In response to detecting that the ambient sound belongs to the at least one predetermined sound class, a pass-through mode of the headset can be automatically enabled (which can greatly improve the convenience in use for the headset), or a notification sound signal can be sent to the speaker (s) of the headset, to notify a user of the headset of class and direction of the ambient sound (which can greatly improve the safety in use for the headset).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a headset according to an embodiment of the present invention.

FIG. 2 is a diagram illustrating an audio system according to an embodiment of the present invention.

FIG. 3 is a flow chart of an ambient sound aware method for a headset according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

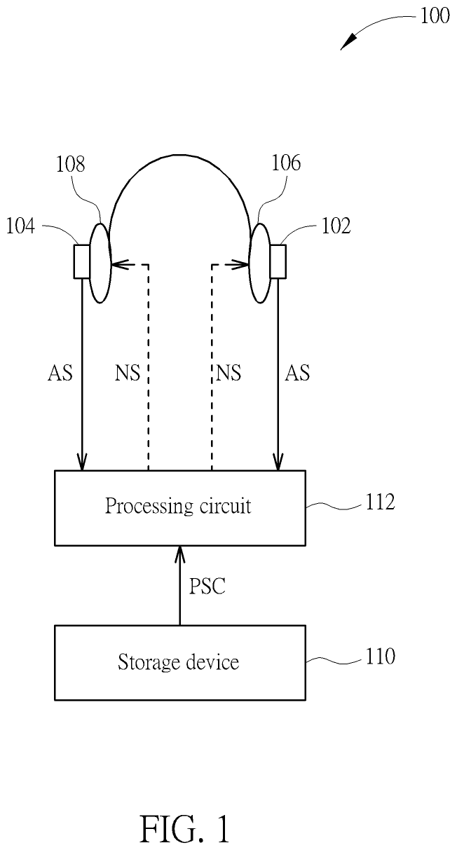

FIG. 1 is a diagram illustrating a headset 100 according to an embodiment of the present invention. As shown in FIG. 1, the headset 100 may have an ambient sound aware function, and may include at least one microphone (MIC; e.g. MICs 102 and 104), at least one speaker (e.g. speakers 106 and 108), a storage device 110, and a processing circuit 112. The MICs 102 and 104 may be arranged to pick up an ambient sound AS, and send the ambient sound AS to the processing circuit 112. The storage device 110 may be arranged to store at least one predetermined sound class (for brevity, labeled as “PSC” in FIG. 1), wherein the at least one predetermined sound class may be set by utilizing an electronic device (e.g. a mobile phone; not shown in FIG. 1) that is connected to the headset 100 through wired communication or wireless communication (e.g. Bluetooth), and may be loaded into the processing circuit 112. Examples of the least one predetermined sound class may include, but are not limited to: alarm sound, ambulance siren, car tires screeching, glass breaking, gun shooting, banging, baby crying, calling a name, and so on.

The processing circuit 112 may be coupled to the storage device 110, and may be arranged to receive the ambient sound AS sent by the MICs 102 and 104, and analyze the ambient sound AS to detect whether the ambient sound AS belongs to the at least one predetermined sound class. In response to detecting that the ambient sound AS belongs to the at least one predetermined sound class, the processing circuit 112 may be further arranged to enable a pass-through mode of the headset 100 without user intervention, send a notification sound signal NS to the speakers 106 and 108 without user intervention, or automatically turn down the volume of an audio signal played by the headset 100, wherein the notification sound signal NS may include a predetermined voice to notify a user of the headset 100 of class and direction (e.g. front, rear, left, or right) of the ambient sound AS. Since the pass-through mode of the headset 100 may be automatically enabled according to a detection result (i.e. a result of detecting whether the ambient sound AS belongs to the at least one predetermined sound class), the convenience in use for the headset 100 can be greatly improved. In addition, by sending the notification sound signal NS to the speakers 106 and 108 of the headset 100 for notifying the user of the headset 100 of the class and the direction of the ambient sound AS, the unsafety in use for the headset 100 can also be improved. On the other hand, in response to detecting that the ambient sound AS does not belong to the at least one predetermined sound class, the processing circuit 112 will not respond to the ambient sound AS.

For example, it is assumed that the at least one predetermined sound class is set to include the ambulance siren and the car tires screeching, and the ambient sound AS is the ambulance siren and comes from left side of the user of the headset 100. In response to detecting that the ambient sound AS belongs to one of the ambulance siren and the car tires screeching, the processing circuit 112 may be further arranged to automatically enable the pass-through mode of the headset 100, or automatically send the notification sound signal NS to the speakers 106 and 108, to notify the user of the headset 100 that the ambient sound AS is the ambulance siren and comes from left side.

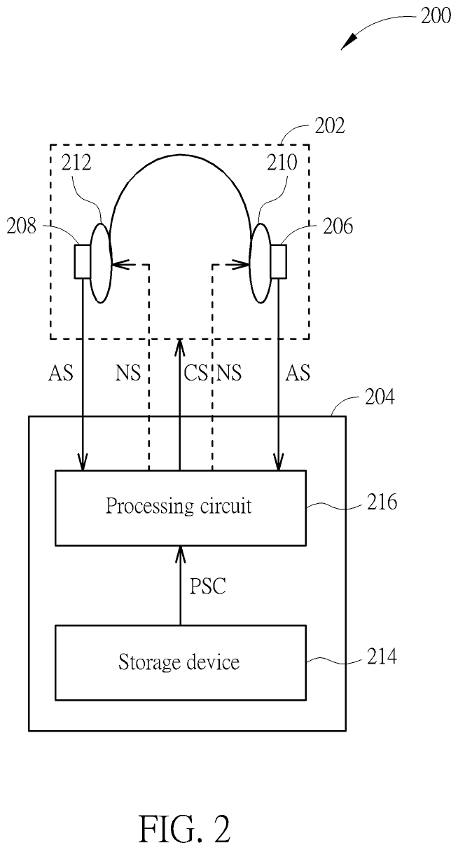

FIG. 2 is a diagram illustrating an audio system. 200 according to an embodiment of the present invention. The difference between the headset 100 shown in FIG. 1 and the audio system 200 shown in FIG. 2 is that the storage device and the processing circuit are not included in the headset but an electronic device external to the headset. As shown in FIG. 2, the audio system 200 may include a headset 202 and an electronic device 204. The audio system 200 may enable the headset 202 to have an ambient sound aware function. Regarding the headset 202, it may include at least one MIC (e.g. MICs 206 and 208) and at least one speaker (e.g. speakers 210 and 212), wherein the MICs 206 and 208 may be arranged to pick up an ambient sound AS. Examples of the electronic device 204 may include, but are not limited to: a mobile phone, a tablet computer, a stereo system, and a personal computer such as a desktop computer and a laptop computer.

The electronic device 204 may include a storage device 214 and a processing circuit 216. The storage device 214 may be arranged to store at least one predetermined class (for brevity, labeled as “PSC” in FIG. 2), which may be loaded into the processing circuit 216. The processing circuit 216 may be coupled to the storage device 214, and may be arranged to receive the ambient sound AS sent by the MICs 206 and 208, and analyze the ambient sound AS to detect whether the ambient sound AS belongs to the at least one predetermined sound class. In response to detecting that the ambient sound AS belongs to the at least one predetermined sound class, the processing circuit 216 may be further arranged to send a control signal CS to the headset 202, wherein a pass-through mode of the headset 202 may be automatically enabled (i.e. the pass-through mode may be enabled without user intervention) according to the control signal CS, or a notification sound signal NS may be automatically sent from the processing circuit 216 to the speakers 210 and 212 (i.e. the notification sound signal NS may be sent without user intervention) according to the control signal CS. For example, the control signal CS may be arranged to control the speakers 210 and 212 to receive the notification sound signal NS.

For brevity, similar descriptions for this embodiment are not repeated in detail here.

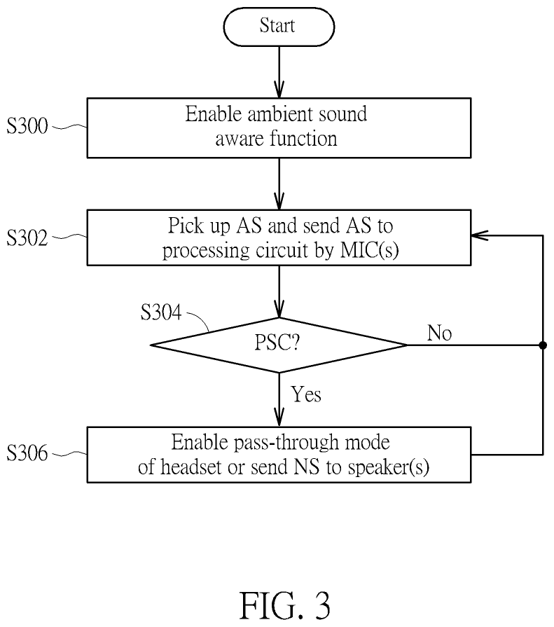

FIG. 3 is a flow chart of an ambient sound aware method for a headset according to an embodiment of the present invention. Provided that the result is substantially the same, the steps are not required to be executed in the exact order shown in FIG. 3. For example, the ambient sound aware method shown in FIG. 3 may be employed by the headset 100 shown in FIG. 1 or the audio system 200 shown in FIG. 2.

In Step S300, the ambient sound aware function of a headset (e.g. the headset 100 in FIG. 1 or the headset 202 in FIG. 2) is enabled.

In Step S302, the ambient sound AS is picked up and sent to a processing circuit (e.g. the processing circuit 112 shown in FIG. 1 or the processing circuit 216 shown in FIG. 2) by the MIC(s) in the headset (e.g. the MICs 102 and 104 shown in FIG. 1 or the MICs 206 and 208 shown in FIG. 2).

In Step S304, the ambient sound AS is analyzed by the processing circuit, to detect whether the ambient sound AS belongs to the at least one predetermined sound class. If yes, Step S306 is entered; if no, Step S300 is returned.

In Step S306, in response to detecting that the ambient sound AS belongs to the at least one predetermined sound class, a pass-through mode of the headset may be enabled automatically, or a notification sound signal NS may be sent to the headset (more particularly, the speaker(s) in the headset; for example, the speakers 106 and 108 shown in FIG. 1 or the speakers 210 and 212 shown in FIG. 2).

Since a person skilled in the pertinent art can readily understand details of the steps after reading above paragraphs directed to the headset 100 shown in FIG. 1 or the audio system 200 shown in FIG. 2, further description is omitted here for brevity.

In summary, the headset (or the audio system that includes the headset and the electronic device) of the present invention can analyze the ambient sound to detect whether the ambient sound belongs to the at least one predetermined sound class. In response to detecting that the ambient sound belongs to the at least one predetermined sound class, a pass-through mode of the headset may can be automatically enabled (which can greatly improve the convenience in use for the headset), or a notification sound signal can be sent to the speaker(s) in the headset, to notify a user of the headset of class and direction of the ambient sound (which can greatly improve the safety in use for the headset).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A headset with ambient sound aware function, comprising:
at least one microphone (MIC), arranged to pick up an ambient sound;
a storage device, arranged to store at least one predetermined sound class; and
a processing circuit, coupled to the storage device, and arranged to receive the ambient sound sent by the at least one MIC, and analyze the ambient sound to detect whether the ambient sound belongs to the at least one predetermined sound class.

2. The headset of claim 1, wherein the processing circuit is further arranged to enable a pass-through mode of the headset in response to detecting that the ambient sound belongs to the at least one predetermined sound class.

3. The headset of claim 1, wherein the headset further comprises:
at least one speaker;
wherein the processing circuit is further arranged to send a notification sound signal to the at least one speaker in response to detecting that the ambient sound belongs to the at least one predetermined sound class.

4. The headset of claim 3, wherein the notification sound signal is arranged to indicate direction of the ambient sound.

5. The headset of claim 3, wherein the notification sound signal is arranged to indicate class of the ambient sound.

6. The headset of claim 1, wherein the processing circuit is further arranged to not respond to the ambient sound in response to detecting that the ambient sound does not belong to the at least one predetermined sound class.

7. An audio system with ambient sound aware function, comprising:
a headset, comprising:
at least one microphone (MIC), arranged to pick up an ambient sound; and
an electronic device, comprising:
a storage device, arranged to store at least one predetermined sound class; and
a processing circuit, coupled to the storage device, and arranged to receive the ambient sound sent by the at least one MIC, and analyze the ambient sound to detect whether the ambient sound belongs to the at least one predetermined sound class.

8. The audio system of claim 7, wherein the processing circuit is further arranged to send a control signal to the headset in response to detecting that the ambient sound belongs to the at least one predetermined sound class.

9. The audio system of claim 8, wherein a pass-through mode of the headset is enabled according to the control signal.

10. The audio system of claim 8, wherein the headset further comprises:
at least one speaker;
wherein a notification sound signal is sent from the processing circuit to the at least one speaker according to the control signal.

11. The audio system of claim 10, wherein the notification sound signal is arranged to indicate direction of the ambient sound.

12. The audio system of claim 10, wherein the notification sound signal is arranged to indicate class of the ambient sound.

13. The audio system of claim 7, wherein the processing circuit is further arranged to not respond to the ambient sound in response to detecting that the ambient sound does not belong to the at least one predetermined sound class.

14. An ambient sound aware method for a headset, wherein the headset comprises at least one microphone (MIC), and the ambient sound aware method comprises:
picking up an ambient sound by the at least one MIC; and
analyzing the ambient sound to detect whether the ambient sound belongs to at least one predetermined sound class.

15. The ambient sound aware method of claim 14, further comprising:
enabling a pass-through mode of the headset in response to the ambient sound belonging to the at least one predetermined sound class.

16. The ambient sound aware method of claim 14, wherein the headset further comprises at least one speaker, and the ambient sound aware method further comprises:
sending a notification sound signal to the at least one speaker in response to the ambient sound belonging to the at least one predetermined sound class.

17. The ambient sound aware method of claim 16, wherein the notification sound signal is arranged to indicate direction of the ambient sound.

18. The ambient sound aware method of claim 16, wherein the notification sound signal is arranged to indicate class of the ambient sound.

19. The ambient sound aware method of claim 14, further comprising: not responding to the ambient sound in response to the ambient sound does not belonging to the at least one predetermined sound class.
